(19) United States
(12) Patent Application Publication
(10) Pub. No.: US 2017/0110723 A1
(43) Pub. Date: Apr. 20, 2017

(54) NONAQUEOUS ELECTROLYTE BATTERY AND BATTERY PACK, AND VEHICLE

(71) Applicant: KABUSHIKI KAISHA TOSHIBA, Minato-ku (JP)

(72) Inventors: Mitsuru ISHIBASHI, Yokohama (JP); Yoshiyuki ISOZAKI, Tokyo (JP); Shinsuke MATSUNO, Tokyo (JP); Norio TAKAMI, Yokohama (JP)

(73) Assignee: KABUSHIKI KAISHA TOSHIBA, Minato-ku (JP)

(21) Appl. No.: 15/392,890

(22) Filed: Dec. 28, 2016

Related U.S. Application Data
(63) Continuation of application No. PCT/JP2014/073790, filed on Sep. 9, 2014.

(51) Int. Cl. H01M 4/485; H01M 10/42; H02J 7/00; H01M 4/136; H01M 4/62; H01M 4/58; H01M 10/0525; H01M 4/131

(52) U.S. Cl. CPC H01M 4/485; H01M 10/0525; H01M 10/425; H01M 4/131; H01M 4/136; H01M 4/622; H01M 4/5825; H02J 7/0026; H01M 2220/20; H01M 2004/027

(57) ABSTRACT

According to one embodiment, a nonaqueous electrolyte battery is a provided. The nonaqueous electrolyte battery includes a positive electrode, a negative electrode and a nonaqueous electrolyte. The positive electrode includes a positive electrode layer. The positive electrode layer includes at least one olivine-type compound and a positive electrode binder. The negative electrode includes a negative electrode layer. The negative electrode layer includes at least one oxide and a negative electrode binder. The positive electrode binder and/or the negative electrode binder include at least one compound selected from the group consisting of a polyacrylic acid, a polyacrylate, and a copolymer thereof.

### CROSS-REFERENCE TO RELATED APPLICATIONS

This application is a Continuation Application of PCT Application No. PCT/JP2014/073790, filed Sep. 9, 2014, the entire contents of which are incorporated herein by reference.

### FIELD

Embodiments described herein relate to a nonaqueous electrolyte battery, a battery pack and a vehicle.

### BACKGROUND

Cobalt and nickel, which are expensive transition metals, are in use for LiCoO₂ and a ternary active material as a conventionally used positive electrode active material. Further, especially a nickel-based active material and the like have a safety problem, also in terms of thermal stability.

In contrast, olivine-type compound materials such as lithium iron phosphate (LiFePO₄) and lithium manganese iron phosphate do not include an expensive transition metal such as cobalt and nickel, and cost reduction can thus be expected. Moreover, such olivine-type compound materials have high thermal stability, and can be expected to have an excellent safety, excellent cycle characteristics, and the like. However, these olivine-type compounds have low electron conductivity, which has been problematic. For dealing with this problem, measures have been taken such as improvement in electron conductivity on the surface by particle pulverization and carbon coating, and reduction in lithium diffusion distance, whereby practical application of the olivine-type compound material has been started.

Meanwhile, as a negative electrode material, titanium oxide has recently attracted attention. A lithium titanate (Li₄Ti₅O₁₂) having a spinel-structure and the like have been used practically because it can be expected to realize an excellent safety and excellent cycle characteristics. Accordingly, it has been expected that a nonaqueous electrolyte battery with a highly excellent stability can be produced by combination of the above negative electrode material with a positive electrode using the olivine-type compound material.

### BRIEF DESCRIPTION OF THE DRAWINGS

FIG. 1 is a sectional view of an example of a nonaqueous electrolyte battery according to a first embodiment.

FIG. 2 is an enlarged sectional view of a portion A of FIG. 1.

FIG. 3 is an exploded perspective view of an example of a battery pack according to a second embodiment.

FIG. 4 is a block diagram showing an electric circuit of the battery pack of FIG. 3.

FIG. 5 shows plots indicating changes in impedance concerning nonaqueous electrolyte batteries according to Example 1.

### DETAILED DESCRIPTION

In general, according to one embodiment, a nonaqueous electrolyte battery is provided. This nonaqueous electrolyte battery includes a positive electrode, a negative electrode, and a nonaqueous electrolyte. The positive electrode includes a positive electrode layer. The positive electrode layer includes at least one compound, and a positive electrode binder. At least one compound is selected from the group consisting of an olivine-type lithium iron phosphate having a specific surface area of 3 m²/g or more and 25 m²/g or less, an olivine-type lithium manganese phosphate having a specific surface area of 15 m²/g or more and 50 m²/g or less, and an olivine-type lithium manganese iron phosphate with a specific surface area of 15 m²/g or more and 50 m²/g or less. The negative electrode includes a negative electrode layer. The negative electrode layer includes at least one oxide and a negative electrode binder. At least one oxide is selected from the group consisting of a lithium titanate having a spinel-structure and a specific surface area of 2 m²/g or more and 20 m²/g or less, a monoclinic β-type titanium composite oxide having a specific surface area of 10 m²/g or more and 30 m²/g or less, and a niobium-containing titanium composite oxide having a specific surface area of 5 m²/g or more and 25 m²/g or less. The positive electrode binder and/or the negative electrode binder include at least one compound selected from the group consisting of a polyacrylic acid, a polyacrylate, and a copolymer thereof.

According to the embodiment, a battery pack is provided. This battery pack includes the nonaqueous electrolyte battery according to the embodiment.

According to the embodiment, a vehicle is provided. This vehicle includes the battery pack according to the embodiment.

The embodiments will be explained below with reference to the drawings. In this case, the structures common to all embodiments are represented by the same symbols and duplicated explanations will be omitted. Also, each drawing is a typical view for explaining the embodiments and for promoting an understanding of the embodiments. Though there are parts different from an actual device in shape, dimension and ratio, these structural designs may be properly changed taking the following explanations and known technologies into consideration.

### First Embodiment

According to a first embodiment, a nonaqueous electrolyte battery is provided. This nonaqueous electrolyte battery includes a positive electrode, a negative electrode, and a nonaqueous electrolyte. The positive electrode includes a positive electrode layer. The positive electrode layer includes at least one olivine-type compound, and a positive electrode binder. At least one olivine-type compound is selected from the group consisting of a lithium iron phosphate having a specific surface area of 3 m²/g or more and 25 m²/g or less, a lithium manganese phosphate having a specific surface area of 15 m²/g or more and 50 m²/g or less, and a lithium manganese iron phosphate with a specific surface area of 15 m²/g or more and 50 m²/g or less. The negative electrode includes a negative electrode layer. The negative electrode layer includes at least one oxide and a negative electrode binder. At least one oxide is selected from the group consisting of a lithium titanate having a spinel-structure and a specific surface area of 2 m²/g or more and 20 m²/g or less, a monoclinic β-type titanium composite oxide having a specific surface area of 10 m²/g or more and 30 m²/g or less, and a niobium-containing titanium composite oxide having a specific surface area of 5 m²/g or more and 25 m²/g or less. The positive electrode binder and/or the negative electrode binder include at least one compound selected from the group consisting of a polyacrylic acid, a polyacrylate, and a copolymer thereof.

An electrode using an olivine-type compound, typically lithium iron phosphate and lithium manganese phosphate, is susceptible to moisture, and especially when a temperature is raised beyond a normal temperature, a problem of gas generation, degradation of battery performance, or the like may occur, which has been problematic. This is because the olivine-type compound is easily degraded due to the influence of moisture or the influence of free acid such as hydrogen fluoride which is generated through reaction between moisture and an electrolytic solution or the like. This influence is noticeable especially when charge-and-discharge cycles are performed at a higher temperature than a room temperature, for example, from 40° C. to 100° C.

Further, titanium oxide is apt to adsorb moisture to its surface, and thus has a problem of bringing moisture to the inside of the battery when used as a negative electrode active material.

For this reason, in a nonaqueous electrolyte battery using in combination a negative electrode negative electrode including the titanium oxide and a positive electrode including the olivine-type compound, moisture brought by the negative electrode including the titanium oxide causes degradation of the positive electrode using the olivine-type compound, which has been problematic. In particular, the degradation in the charge-and-discharge cycles at a higher temperature than the room temperature, for example, from 40° C. to 100° C., is large.

As a result of intensive studies, the present inventors found that by using, as a positive electrode binder and/or a negative electrode binder, a polyacrylic acid compound selected from the group consisting of a polyacrylic acid, a polyacrylate, and a copolymer thereof, and by using in combination at least one olivine-type compound selected from the group consisting of a lithium iron phosphate having a specific surface area of 3 m²/g or more and 25 m²/g or less, a lithium manganese phosphate having a specific surface area of 15 m²/g or more and 50 m²/g or less, and a lithium manganese iron phosphate having a specific surface area of 15 m²/g or more and 50 m²/g or less, and at least one oxide selected from the group consisting of a lithium titanate having a spinel-structure and a specific surface area of 2 m²/g or more and 20 m²/g or less, a monoclinic β-type titanium composite oxide having a specific surface area of 10 m²/g or more and 30 m²/g or less, and a niobium-containing titanium composite oxide having a specific surface area of 5 m²/g or more and 25 m²/g or less, it is possible to restrain an influence of moisture on the olivine-type compound and restrain degradation of the positive electrode, especially degradation of the positive electrode when the temperature is high, and thereby to restrain an increase in impedance due to cycles at a high temperature.

The polyacrylic acid compound selected from the group consisting of the polyacrylic acid, the polyacrylate, and the copolymer thereof is an absorbent resin used for a diaper and the like as a polymer absorber. In the nonaqueous electrolyte battery, the polyacrylic acid compound included in the positive electrode binder and/or the negative electrode binder can exert the effect of trapping moisture which was adsorbed to the surface of the electrode active material or the like and therefore was brought into the battery. Further, since the polyacrylic acid compound can show an excellent coatability on the electrode active material, it is also possible to restrain a decomposition reaction of the electrolytic solution which occurs on the surface of the electrode active material, and thereby to restrain an increase in impedance of the electrode.

The larger the specific surface area of the negative electrode active material, the larger the quantity of moisture that is adsorbed to the negative electrode active material. Further, the larger the specific surface area of the positive electrode active material, the larger the number of reactions brought about with moisture, the free acid, and the electrolytic solution. Therefore, the larger the specific surface area of the positive electrode active material, the more noticeable the effect of being able to restrain the decomposition reaction of the electrolytic solution, the effect being exerted by the excellent coatability. Should be noted that the range of the specific surface area in which the above effect noticeably appears varies with respect to each kind of active material.

As thus described, the nonaqueous electrolyte battery according to the first embodiment can restrain the degradation of the positive electrode and the increase in impedance especially during the cycles at a high temperature which occur due to moisture that can be brought into the battery by the titanium-containing oxide, for example. Accordingly, the nonaqueous electrolyte battery according to the first embodiment can show improved cycle life characteristics, and can restrain the increase in impedance.

Next, the nonaqueous electrolyte battery according to the first embodiment is described in more detail.

The nonaqueous electrolyte battery according to the first embodiment includes a positive electrode, a negative electrode, and a nonaqueous electrolyte.

The positive electrode includes a positive electrode layer. The positive electrode can further include a positive electrode current collector. The positive electrode layer can be supported on each surface or one surface of the positive electrode current collector. The positive electrode current collector can include a portion not supporting the positive electrode layer.

The positive electrode layer includes at least one olivine-type compound. At least one olivine-type compound is selected from the group consisting of lithium iron phosphate, lithium manganese phosphate, and lithium manganese iron phosphate. Each of these olivine-type compounds can act as a positive electrode active material. The positive electrode layer can include a further positive electrode active material. The positive electrode layer further includes the positive electrode binder. Optionally, the positive electrode layer can further include a conductive agent.

The negative electrode includes a negative electrode layer. The negative electrode can further include a negative electrode current collector. The negative electrode layer can be supported on each surface or one surface of the negative electrode current collector. The negative electrode current collector can include a portion not supporting the negative electrode layer.

The negative electrode layer includes at least one oxide. At least one oxide is selected from the group consisting of a lithium titanate having a spinel-type structure, a monoclinic β-type titanium composite oxide, and a niobium-containing titanium composite oxide. Each of these oxides can act as a negative electrode active material. The negative electrode layer can include a further negative electrode active material. The negative electrode layer further includes the negative electrode binder. Optionally, the negative electrode layer can further includes a conductive agent.

The nonaqueous electrolyte battery according to the first embodiment can further include a separator. The separator can be provided between the positive electrode layer and the negative electrode layer. The positive electrode, the negative electrode, and the separator can constitute an electrode group.

Such an electrode group may have a stacked structure, for example. The stacked structure is a structure in which a plurality of positive electrodes and a plurality of negative electrodes are stacked with the separator sandwiched between the positive electrode layer and the negative electrode layer. Alternatively, the electrode group may have a wound structure. The wound structure is a structure in which a structure, formed by laminating the positive electrode to the negative electrode with the separator sandwiched the positive electrode layer and the negative electrode layer, is wound around a winding axis.

The nonaqueous electrolyte can be impregnate into such an electrode group and then held therein.

The nonaqueous electrolyte battery according to the first embodiment can further include a container member. The container member can accommodate the electrode group and the nonaqueous electrolyte.

The nonaqueous electrolyte battery according to the first embodiment can further include a positive electrode terminal and a negative electrode terminal. The positive electrode terminal is electrically connected to the positive electrode, and at least one end of the positive electrode terminal is located outside the container member. Similarly, the negative electrode terminal is electrically connected to the negative electrode, and at least one end of the negative electrode terminal is located outside the container member.

Next, the positive electrode binder and the negative electrode binder of the nonaqueous electrolyte battery according to the first embodiment will be described in detail.

The positive electrode binder and the negative electrode binder can be respectively used to bind the active material and the conductive agent.

As a polyacrylic acid compound included in the positive electrode binder and/or the negative electrode binder, a polyacrylic acid, a polyacrylate, and a copolymer of the polyacrylic acid and the polyacrylate can be used.

As polyacrylate, for example, a polyacrylate neutralized by an alkali metal or an alkaline earth metal including Mg and Be, and the like can be used. Sodium polyacrylate or lithium polyacrylate, neutralized by Na or Li, is preferably used. Further, polyacrylate can also be used as a copolymer formed with polyacrylic acid. That is, there can be used a compound where part of polyacrylic acid has been neutralized by the foregoing alkali metal or alkaline earth metal.

The positive electrode including the positive electrode layer that includes the positive electrode binder can be manufactured by, for example, dissolving the positive electrode binder and another material to be included in the positive electrode layer into an appropriate solvent to prepare a positive electrode slurry, and applying this slurry to an appropriate substrate, specifically the positive electrode current collector, followed by drying and pressing. The negative electrode can also be manufactured in the same manner.

Examples of the solvent used for preparing the positive electrode slurry and/or the negative electrode slurry include water, and an organic solvent such as N-methylpyrrolidone (NMP), dimethylformamide, dimethylacetamide, and methylformamide. Should be noted that since polyacrylate has low solubility in the organic solvent, water is preferably used in the case where a slurry including the polyacrylate is prepared. Since the positive electrode and the negative electrode can be manufactured by, for example, the manufacturing method including the drying process as described above, water used for the solvent can be removed from the electrode by the drying process.

Further, it was found that, regardless of whether NMP is used or water is used at the time of preparing the slurry, the increase in impedance can be restrained by using the polyacrylate in combination with the olivine-type compound and the titanium-containing compound.

A blending amount of the binder is desirably from 1% by mass to 20% by mass with respect to the mass of the positive electrode active material and/or negative electrode active material. A binder with its blending amount within this range can exert sufficient binding strength and keep a proportion of an insulator in the electrode low, to prevent an increase in internal resistance.

A weight-average molecular weight of the polyacrylic acid compound is desirably from 10000 to 5000000. When the molecular weight is within this range, the viscosity can be easily adjusted at the time of application to the current collector. The weight-average molecular weight is more preferably from 100000 to 3000000, and in this case, the viscosity can be even more easily adjusted. The polyacrylic acid compound is not particularly required to be cross-linked, but may be cross-linked.

The positive electrode binder or the negative electrode binder, whichever binder includes the polyacrylic acid compound, can prevent degradation of the positive electrode due, for example, to moisture adsorbed to the surface of the negative electrode active material and brought in. Hence the polyacrylic acid compound may be included in either the positive electrode binder or the negative electrode binder. In other words, so long as either the positive electrode binder or the negative electrode binder includes the polyacrylic acid compound, the other may not include the polyacrylic acid compound. Naturally, both the positive electrode binder and the negative electrode binder may each include the polyacrylic acid compound. It is more desirable that the positive electrode binder include the polyacrylic acid compound. The positive electrode binder and the negative electrode binder may be binders including different components.

The positive electrode binder and/or the negative electrode binder can further include a material having a binding function other than the polyacrylic acid compound. When another binder is to be included, a proportion of the polyacrylic acid compound is preferably 10% by mass or more. The polyacrylic acid is more desirably 25% by mass or more. Setting the polyacrylic acid to 10% by mass or more enables further restraint of an increase in resistance of the electrode in the charge-and-discharge cycles.

For example, when the organic solvent such as NMP is to be used as the solvent, a mixture of the polyacrylic acid and an acrylonitrile-based binder can be used. In this case, a preferable proportion of the mixture is such that polyacrylic acid is 10% by mass or more with respect to the mass of the binder. The polyacrylic acid is more desirably 25% by mass or more. Setting the polyacrylic acid to 10% by mass or more enables further restraint of an increase in resistance of the electrode in the charge-and-discharge cycles. Further including the acrylonitrile-based binder in the electrode layer can further enhance binding properties of the electrode layer.

Alternatively, when water is to be used as the solvent, for example, a mixture of a polyacrylic acid compound and a styrene-butadiene copolymer (styrene-butadiene rubber (SBR)) can be used. In this case, the mixing proportion is such that SBR is preferably 0.5% by mass or more and 10% by mass or less with respect to the mass of the binder. Including SBR can enhance the binding properties of the electrode layer. Setting the blending amount of SBR within this range can lead to further sufficient binding properties. Further, setting the blending amount of SBR within this range can restrain the increase in internal resistance of the electrode due to the insulating properties of the binder, and the aggregation in the applied slurry.

It is also possible to include another binder other than the polyacrylic acid compound, the acrylonitrile-based binder, and SBR. As another binder, for example, a water-soluble polymer can be used. Examples thereof include carboxymethyl cellulose. Using carboxymethyl cellulose enables the viscosity adjustment of the coating solution for the electrode, the flexibility adjustment of the electrode, and the like.

When not including the polyacrylic acid compound, the positive electrode binder or the negative electrode binder can include, for example, polyvinylidene fluoride (PVdF), polytetrafluoroethylene (PTFE), fluoro-rubber, acrylic rubber, styrene-butadiene copolymer rubber (SBR), and the like, though this is not particularly limited.

As a simple method among methods for analyzing the polyacrylic acid binder in the electrode, there is used a method for analyzing the electrode surface by infrared spectroscopy (ATR (Attenuated Total Reflection) method), or some other method. Further, it is also possible to perform the analysis by extracting a binder from the electrode by dissolving it using water or an organic solvent (NMP, etc.) in which the polyacrylic acid can be dissolved, performing filteration to remove the active material and the conductive agent, and then performing GC-MS (Gas Chromatography-Mass Spectrometry), LC-MS (Liquid Chromatography-Mass Spectrometry), FT-IR (Fourier Transform-Infrared Spectroscopy), or the like.

Next, constituting members, other than the positive electrode binder and the negative electrode binder, of the nonaqueous electrolyte battery according to the first embodiment will be described below.

1. Positive Electrode

(Positive Electrode Active Material)

The positive electrode active material includes at least one olivine-type compound selected from the group consisting of a lithium iron phosphate (LiₓFePO₄; 0≦x≦1.1) with a specific surface area of 3 m²/g or more and 25 m²/g or less, a lithium manganese phosphate (LiₓMnPO₄; 0≦x≦1.1) with a specific surface area of 15 m²/g or more and 50 m²/g or less, and a lithium manganese iron phosphate (LiₓFe_{1-y}Mn_{y}PO₄; 0≦x≦1.1, 0<y<1) with a specific surface area of 15 m²/g or more and 50 m²/g or less. Other examples of the olivine-type compound include a lithium nickel phosphate (LiₓNiPO₄; 0≦x≦1.1) and a lithium cobalt phosphate (LiₓCoPO₄; 0≦x≦1.1). Such a positive electrode active material is low-cost as it does not containing an expensive transition metal, and has high thermal stability. For this reason, by use of such a positive electrode active material, an excellent safety, cycle characteristics, and the like can be expected.

The specific surface area of the active material can be obtained by using an active material powder as a sample, adsorbing molecules with a known occupation area to the powder particle surface at a liquid nitrogen temperature, and measuring the amount of the adsorbed molecules, to find a specific surface area of the sample. The most frequently used method is the BET (Brunauer-Emmett-Teller) method by low-temperature and low-moisture physical adsorption of an inert gas such as nitrogen. A specific surface area obtained thereby is referred to as a BET specific surface area.

The specific surface area of the lithium iron phosphate is preferably 8 m²/g or more and 20 m²/g or less. The specific surface area of lithium manganese phosphate is preferably 15 m²/g or more and 30 m²/g or less. The specific surface area of lithium manganese iron phosphate is preferably 18 m²/g or more and 40 m²/g or less.

The positive electrode active material preferably has a primary particle size of 1 μm or less, and more preferably from 0.01 to 0.5 μm. The positive electrode active material having such a primary particle size can reduce influences of electronic conduction resistance and lithium-ion diffusing resistance therein, to improve output performance. Should be noted that the primary particles may be aggregated to form a secondary particle having 30 μm or less.

The positive electrode active material desirably has a carbonaceous coating film on the surface so as to have favorable conductivity. The carbonaceous coating film is a coating film obtained by performing thermal-treatment on an organic substance to be a carbon source in a non-oxidizing atmosphere, and this carbonaceous coating film preferably includes 30% by mass or more and 100% by mass or less of carbon. The carbonaceous coating film preferably has a thickness of 0.1 nm or more and 25 nm or less. While the organic substance to be the carbon source is not particularly limited, examples thereof include water-soluble phenol resin, and, other than this, higher monohydroxy alcohol such as hexanol and octanol, unsaturated monohydric alcohol such as allyl alcohol, propynol (propargyl alcohol), and terpineol, and polyvinyl alcohol (PVA).

(Conductive Agent)

The conductive agent is used to improve current-collecting performance of the positive electrode layer, and to reduce the contact resistance between the positive electrode layer and the positive electrode current collector. Examples of the conductive agent include carbonaceous substances such as acetylene black, carbon black, graphite, carbon nano-fiber, and carbon nano-tube.

(Blending Ratio)

The positive electrode active material, the conductive agent, and the binder in the positive electrode layer are blended preferably in a proportion of 80% by mass or more and 95% by mass or less, 3% by mass or more and 18% by mass or less, and 2% by mass or more and 17% by mass or less, respectively. By setting an amount of the conductive agent to 3% by mass or more, it is possible to exert the foregoing effect. By setting the amount of the conductive agent to 18% by mass or less, it is possible to reduce decomposition of the nonaqueous electrolyte on the surface of the conductive agent in storage at a high temperature. By setting a quantity of the binder to 2% by mass or more, it is possible to obtain sufficient positive electrode strength. By setting the amount of the binder to 17% by mass or less, it is possible to reduce a blending amount of the binder as an insulating material in the positive electrode layer, and thereby to reduce the internal resistance.

(Positive Electrode Current Collector)

The positive electrode current collector is preferably an aluminum foil, or an aluminum alloy foil containing one or more elements selected from Mg, Ti, Zn, Mn, Fe, Cu, and Si.

2. Negative Electrode

(Negative Electrode Active Material)

The negative electrode active material includes at least one oxide selected from the group consisting of a lithium titanate (Li₄₊ₓTi₅O₁₂; −1≦x≦3) having a spinel-type structure and a specific surface area of 2 m²/g or more and 20 m²/g or less, a monoclinic β-type titanium composite oxide (TiO₂(B)) with a specific surface area of 10 m²/g or more and 30 m²/g or less, and a niobium-containing titanium composite oxide with a specific surface area of 5 m²/g or more and 25 m²/g or less.

Here, the monoclinic β-type titanium composite oxide means a titanium composite oxide having a crystal structure of a monoclinic titanium dioxide. The crystal structure of monoclinic titanium dioxide mainly belongs to a space group C2/m, showing a tunnel structure. Note that what is described in G. Armstrong, A. R. Armstrong, J. Canales, P. G. Bruce, Electrochem. Solid-State Lett., 9, A139 (2006) applies to a detailed crystal structure of monoclinic titanium dioxide.

Further, as the niobium-containing titanium composite oxide, there can be used a niobium-titanium composite oxide represented by the general formula of TiNb₂O₇, and a composite oxide being such a niobium-titanium composite oxide and containing at least one element selected from the group consisting of B, Na, Mg, Al, Si, S, P, K, Ca, Mo, W, V, Cr, Mn, Co, Ni, and Fe.

The specific surface area of lithium titanate having a spinel-type structure is preferably 2 m²/g or more and 15 m²/g or less. The specific surface area of monoclinic p-type titanium composite oxide is preferably 12 m²/g or more and 22 m²/g or less. The specific surface area of niobium-containing titanium composite oxide is preferably 8 m²/g or more and 18 m²/g or less.

In addition to the above oxides, the negative electrode active material can also include another negative electrode active material.

As another negative electrode active material, for example, a titanium-containing composite oxide can be used. Examples of such a titanium-containing composite oxide include: a titanium-based oxide which includes no lithium during synthesis of the oxide, a titanium composite oxide including a hetero element in place of a part of constituent elements of the titanium-based oxide; a lithium-titanium oxide, and a lithium-titanium composite oxide containing a hetero element in place of a part of constituent elements of the lithium-titanium oxide.

Examples of the lithium-titanium oxide include a lithium-titanium oxide such as LiₓTiO₂, an oxide represented by the general formula of Li₂₊ₓTi₃O₇ and having a ramsdellite structure, and an oxide represented by Li₁₊ₓTi₂O₄, Li_{1.1+x}Ti_{1.8}O₄, Li_{1.07+x}Ti_{1.86}O₄, or LiₓTiO₂ (0≦x). The lithium-titanium oxide is more preferably an oxide represented by the general formula of Li₂₊ₓTi₃O₇ or Li_{1.1+x}Ti_{1.8}O₄. Examples of the titanium-based oxide include TiO₂, and a metal composite oxide containing Ti and at least one element selected from the group consisting of P, V, Sn, Cu, Ni, Co and Fe. Preferable TiO₂ has an anatase structure and low crystallinity, which had been subjected to a thermal treatment at a temperature of 300° C. to 500° C. Examples of the metal composite oxide containing Ti and at least one element selected from the group consisting of P, V, Sn, Cu, Ni, Co, and Fe include TiO₂—P₂O₅, TiO₂—V₂O₅, TiO₂—P₂O₅—SnO₂, and TiO₂—P₂O₅-MeO (Me is at least one element selected from the group consisting of Cu, Ni, Co, and Fe). This metal composite oxide preferably has a microstructure with a crystal phase and an amorphous phase coexistent, or with a crystal phase singly existent. With such a microstructure, the cycle performance can be improved to a large degree.

Among these, as other negative electrode active materials, a lithium-titanium oxide, and a metal composite oxide containing Ti and at least one element selected from the group consisting of P, V, Sn, Cu, Ni, Co, and Fe are preferred. These other negative electrode active materials can be used singly or in combination.

The negative electrode active material preferably has an average primary particle size of 0.001 μm to 1 μm. It is more preferably 0.3 μm or less. Here, the particle size of the negative electrode active material can be measured by such a method as follows, using a laser diffraction particle-size distribution analyzer (SALD-300, manufactured by Shimadzu Corporation). About 0.1 g of a sample, a surfactant, and 1 to 2 mL of distilled water are put into a beaker and sufficiently agitated, and then, the obtained matter is poured into an agitation water-tank. Light intensity distributions are measured using the laser diffraction particle-size distribution analyzer 64 times with intervals of two seconds, and an average primary particle size of the negative electrode active material is measured by a method for analyzing particle size distribution data. Even when the specific surface area of the negative electrode layer is set to as large as 3 to 50 m²/g, by using a negative electrode active material with an average primary particle size within the range of 0.001 to 1 μm, it is possible to avoid reduction in porosity of the negative electrode, and prevent aggregation of the particles. It is thereby possible to prevent a distribution of the nonaqueous electrolyte in an exterior container from being biased to the negative electrode, and prevent the electrolyte from being depleted in the positive electrode.

Without regard to the particle shape of the negative electrode active material having either a granular or fibrous shape, it is possible to obtain favorable performance. When the particles have the fibrous shape, a fiber diameter is preferably 0.1 μm or less.

The negative electrode active material preferably has an average particle size of 1 μm or less, and the negative electrode layer including this active material preferably has a specific surface area of 3 to 50 m²/g measured by the BET method using N₂ adsorption. A negative electrode provided with the negative electrode layer having such a specific surface area and the negative electrode active material with such an average particle size can further enhance its affinity for the nonaqueous electrolyte. This is because, when the specific surface area of the negative electrode layer is within the range of 3 to 50 m²/g, the particles can be prevented from being aggregated. This aggregation leads to reduction in affinity between the negative electrode and the nonaqueous electrolyte and an increase in interface resistance of the negative electrode. Therefore, it is possible to exert excellent output characteristics and excellent charge-and-discharge cycle characteristics. Further, when the specific surface area of the negative electrode layer is within the range of 3 to 50 m²/g, the distribution of the nonaqueous electrolyte in the exterior container can be made uniform, to prevent excess or deficiency of the nonaqueous electrolyte in the positive electrode, and further to achieve improvement in output characteristics and charge-and-discharge cycle characteristics. A more preferable specific surface area of the negative electrode layer is from 5 to 50 m²/g.

(Conductive Agent)

The conductive agent is used to improve the current-collecting performance of the negative electrode layer, and suppress the contact resistance between the negative electrode layer and the negative electrode current collector. Examples of the conductive agent include acetylene black, Ketjen black, carbon black, graphite, carbon nanotube such as vapor grown carbon fiber (VGCF), and activated carbon. Since graphite has a plate-shape and high slidability, it can increase an electrode density without biasing the orientation of the particles of the titanium-containing composite oxide. However, for example in the titanium-based oxide, sufficient life characteristics cannot be obtained only by use of graphite, and hence acetylene black is preferably used.

(Blending Ratio)

The negative electrode active material, the conductive agent, and the binder in the negative electrode layer are blended preferably in a proportion of 85% by mass or more and 97% by mass or less, 2% by mass or more and 20% by mass or less, and 2% by mass or more and 16% by mass or less, respectively. With 2% by mass or more of the conductive agent included, it is possible to improve the current-collecting performance of the negative electrode layer, and improve the large-current characteristics of the nonaqueous electrolyte battery. With 2% by mass or more of the binder included, it is possible to improve the binding properties between the negative electrode layer and the negative electrode current collector, and obtain favorable cycle characteristics. Meanwhile, from the viewpoint of achieving a high capacity, contents of the conductive agent and the binder are preferably 20% by mass or less and 16% by mass or less, respectively.

(Negative Electrode Current Collector)

The negative electrode current collector is formed of metal foil. The negative electrode current collector is typically formed of aluminum foil, or aluminum alloy foil containing an element such as Mg, Ti, Zn, Mn, Fe, Cu, and Si.

3. Separator

As the separator, there is used a non-woven fabric made of synthetic resin, a porous film formed of a material such as polyethylene, polypropylene, cellulose, or polyvinylidene fluoride (PVdF), or the like. Among them, the porous film formed of polyethylene or polypropylene can be melt at a certain temperature to break a current, and is thus preferred from the viewpoint of improving the safety.

4. Nonaqueous Electrolyte

As the nonaqueous electrolyte, a liquid nonaqueous electrolyte or a gel nonaqueous electrolyte can be used. The liquid nonaqueous electrolyte can be prepared by dissolving an electrolyte in an organic solvent. A preferable concentration of the electrolyte is within a range of 0.5 to 2.5 mol/l. The gel nonaqueous electrolyte is prepared by obtaining a composite of a liquid electrolyte and a polymer material.

Examples of the electrolyte include lithium salts such as lithium perchlorate (LiClO₄), lithium hexafluorophosphate (LiPF₆), lithium tetrafluoroborate (LiBF₄), lithium hexafluoroarsenate (LiAsF₆), lithium trifluoromethanesulfonate (LiCF₃SO₃), and lithium bistrifluoromethylsulfonyl imide [LiN(CF₃SO₂)₂]. These electrolytes can be used singly or in combination of two or more of them. The electrolyte preferably includes LiN(CF₃SO₂)₂.

Examples of the organic solvent include: a cyclic carbonate such as propylene carbonate (PC), ethylene carbonate (EC), and vinylene carbonate; chain carbonate such as diethyl carbonate (DEC), dimethyl carbonate (DMC), and methylethyl carbonate (MEC); a cyclic ether such as tetrahydrofuran (THF), 2-methyltetrahydrofuran (2MeTHF), and dioxolane (DOX); chain ether such as dimethoxyethane (DME), and diethoxyethane (DEE); γ-butyrolactone (GBL); acetonitrile (AN); and sulfolane (SL). These organic solvents can be used singly or in combination of two or more of them.

Examples of a more preferable organic solvent include a mixed solvent obtained by mixing two or more selected from the group consisting of propylene carbonate (PC), ethylene carbonate (EC), diethyl carbonate (DEC), dimethyl carbonate (DMC), and methylethyl carbonate (MEC), and a mixed solvent containing γ-butyrolactone (GBL). By use of such a mixed solvent, a nonaqueous electrolyte battery excellent in low-temperature characteristics can be obtained.

Examples of the polymer material include polyvinylidene fluoride (PVdF), polyacrylonitrile (PAN), and polyethylene oxide (PEO).

5. Container Member

As the container member, a bag-like container made of a laminate film, or a metal-made container, can be used.

The shape thereof is not particularly limited, and a variety of shapes are possible according to the application of the nonaqueous electrolyte battery according to the first embodiment, for example, a flat shape, a square shape, a cylindrical shape, a coin shape, a button shape, a sheet shape, and a lamination shape. Naturally, the application of the nonaqueous electrolyte battery according to the first embodiment may be a large-sized battery mounted on a two-wheeled or four-wheeled automobile, other than a small-sized battery mounted on a portable electronic device, or the like.

As the laminate film, there is used a multilayer film where a metal layer is sandwiched between resin films. The metal layer is preferably aluminum foil or aluminum alloy foil for weight reduction. As the resin film, there can be used a polymer material such as polypropylene (PP), polyethylene (PE), nylon, or polyethylene terephthalate (PET). The laminate film can be sealed by heat sealing to be formed into the shape of the container member. A preferable thickness of the laminate film is 0.2 mm or less.

The metal-made container can be formed of aluminum or an aluminum alloy, for example. The aluminum alloy preferably contains an element such as magnesium, zinc, or silicon. Meanwhile, a preferable content of the transition metal such as iron, copper, nickel, and chromium is not larger than 1% by mass. It is thereby possible to significantly improve the long-term reliability and heat-radiability under a high-temperature environment. The thickness of the metal-made container is preferably 0.5 mm or less, and more preferably 0.2 mm or less.

6. Positive Electrode Terminal

The positive electrode terminal is formed of a material which is electrically stable at a potential within a range of 3.0 V to 4.5 V with respect to Li/Li⁺ and has an electrically conductivity. The positive electrode terminal is preferably formed of aluminum, or an aluminum alloy containing an element such as Mg, Ti, Zn, Mn, Fe, Cu, and Si. The positive electrode terminal is preferably formed of a similar material to that of the positive electrode current collector, so as to reduce the contact resistance with the positive electrode current collector.

7. Negative Electrode Terminal

The negative electrode terminal is formed of a material which is electrically stable at a potential within a range of 1.0 V to 3.0 V with respect to Li/Li⁺ and has an electrically conductivity. The negative electrode terminal is typically formed of aluminum, or an aluminum alloy foil containing an element such as Mg, Ti, Zn, Mn, Fe, Cu, and Si. The negative electrode terminal is preferably formed of a similar material to that of the negative electrode current collector, so as to reduce the contact resistance with the negative electrode current collector.

Next, an example of the nonaqueous electrolyte battery according to the first embodiment will be described in detail with reference to the drawings.

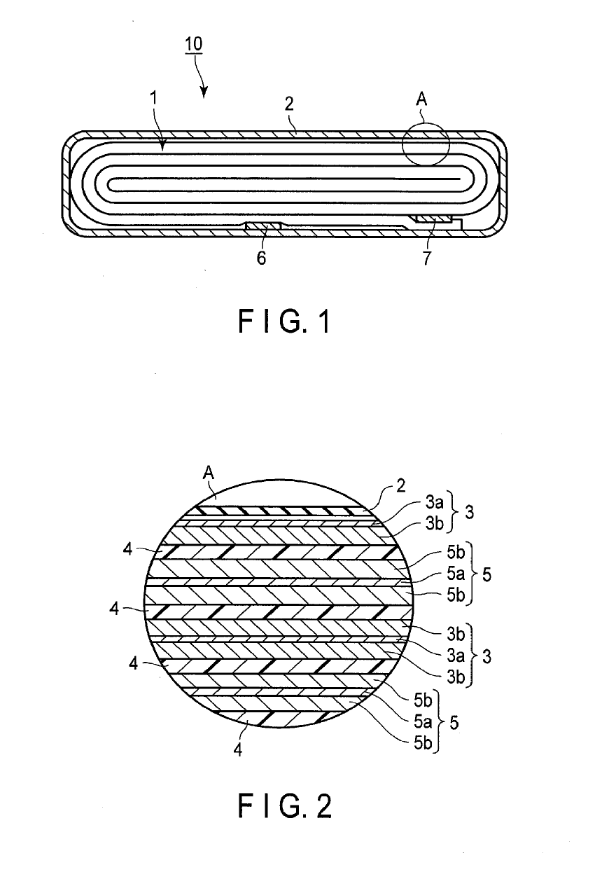

FIG. 1 is a schematic sectional view of an example of the nonaqueous electrolyte battery according to the first embodiment. FIG. 2 is an enlarged sectional view of a portion A of FIG. 1.

A nonaqueous electrolyte battery 10 shown in FIGS. 1 and 2 is a flat-shaped nonaqueous electrolyte battery.

The battery 10 includes a flat-shaped electrode group 1, a nonaqueous electrolyte (not shown) impregnated into the electrode group 1, and a container member 2 accommodating the electrode group 1 and the nonaqueous electrolyte.

As shown in FIG. 2, the electrode group 1 includes a negative electrode 3, a separator 4, and a positive electrode 5.

The negative electrode 3 includes a negative electrode current collector 3a, and a negative electrode layer 3b formed on the negative electrode current collector 3a. In the battery 10 shown in FIGS. 1 and 2, the negative electrode 3 is located on the outermost periphery of the wound electrode group 1. In a portion located on the outermost periphery of the negative electrode 3, the negative electrode layer 3b is formed only on one surface, the inner-side surface, of the negative electrode current collector 3a. In the other portion, the negative electrode layer 3b is formed on each surface of the negative electrode current collector 3a.

The positive electrode 5 includes a positive electrode current collector 5a, and a positive electrode layer 5b formed on each surface of the positive electrode current collector 5a.

The separator 4 is located between the negative electrode layer 3b and the positive electrode layer 5b.

The electrode group 1 is formed by spirally winding a laminate obtained by laminating the negative electrode 3, the separator 4, the positive electrode 5, and the separator 4 in this order, and performing press molding.

As shown in FIG. 1, a belt-like negative electrode terminal 6 is connected to the negative electrode current collector 3a on the outermost periphery of the wound electrode group 1. Further, a belt-like positive electrode terminal 7 is connected to the positive electrode current collector 5a in the vicinity of the outer peripheral end of the wound electrode group 1. The negative electrode terminal 6 and the positive electrode terminal 7 are extended to the outside through an opening of the container member 2.

The container member 2 is a bag-like exterior container made of a laminate film. The nonaqueous electrolyte is poured into the container member 2 via an inlet provided in the container member 2. The container member 2 completely seals the wound electrode group 1 and the nonaqueous electrolyte by heat-sealing opening of container member 2 while sandwiching the negative electrode terminal 6 and the positive electrode terminal 7.

According to the first embodiment, the nonaqueous electrolyte battery is provided. This nonaqueous electrolyte battery includes: the positive electrode layer including the positive electrode binder and at least one olivine-type compound having a specific surface area of a certain value; and the negative electrode layer including at least one oxide having a specific surface area of a certain value. The positive electrode binder and/or the negative electrode binder include at least one polyacrylic acid compound. Due to these, the nonaqueous electrolyte battery according to the first embodiment can exhibit improved cycle life characteristics, and can restrain the increase in impedance.

### Second Embodiment

According to a second embodiment, a battery pack is provided. This battery pack includes the nonaqueous electrolyte battery according to the first embodiment.

The battery pack according to the second embodiment may include one nonaqueous electrolyte battery according to the first embodiment, or may include a plurality of such. Further, the battery pack according to the second embodiment can include a power distribution terminal to the external equipment (an external power distribution terminal).

Next, an example of the battery pack according to the second embodiment will be described in detail with reference to the drawings.

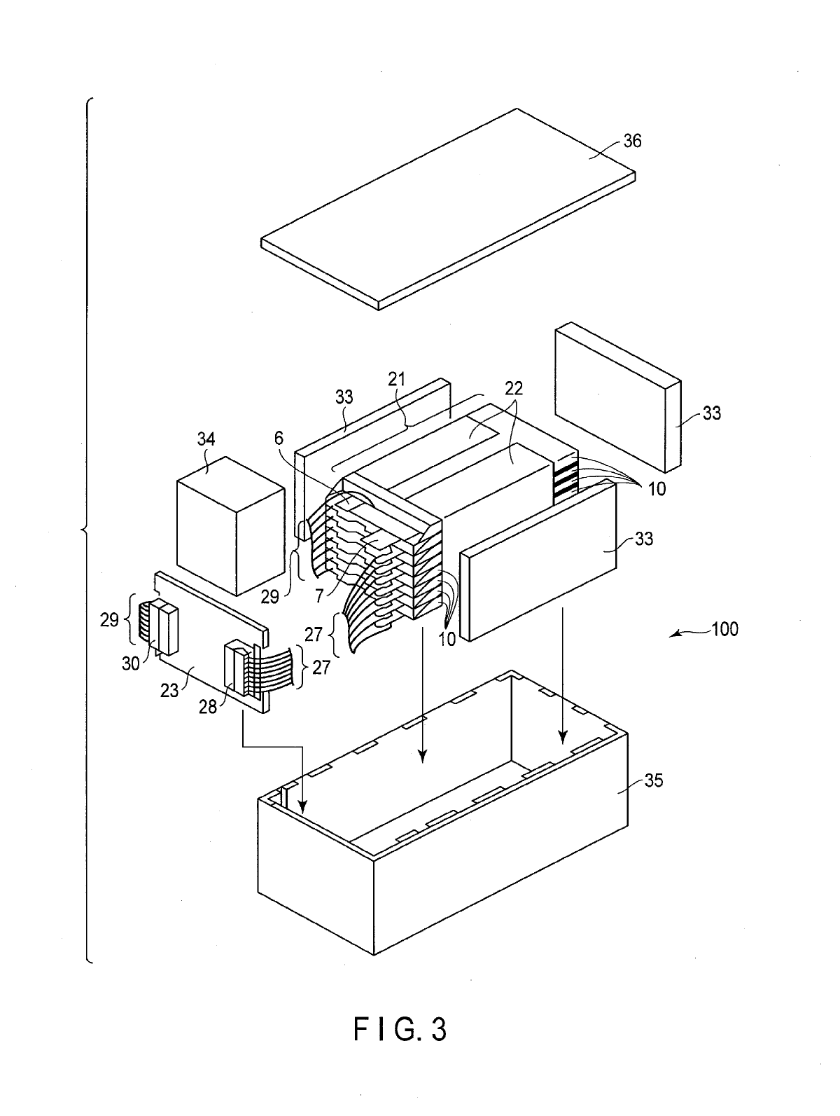

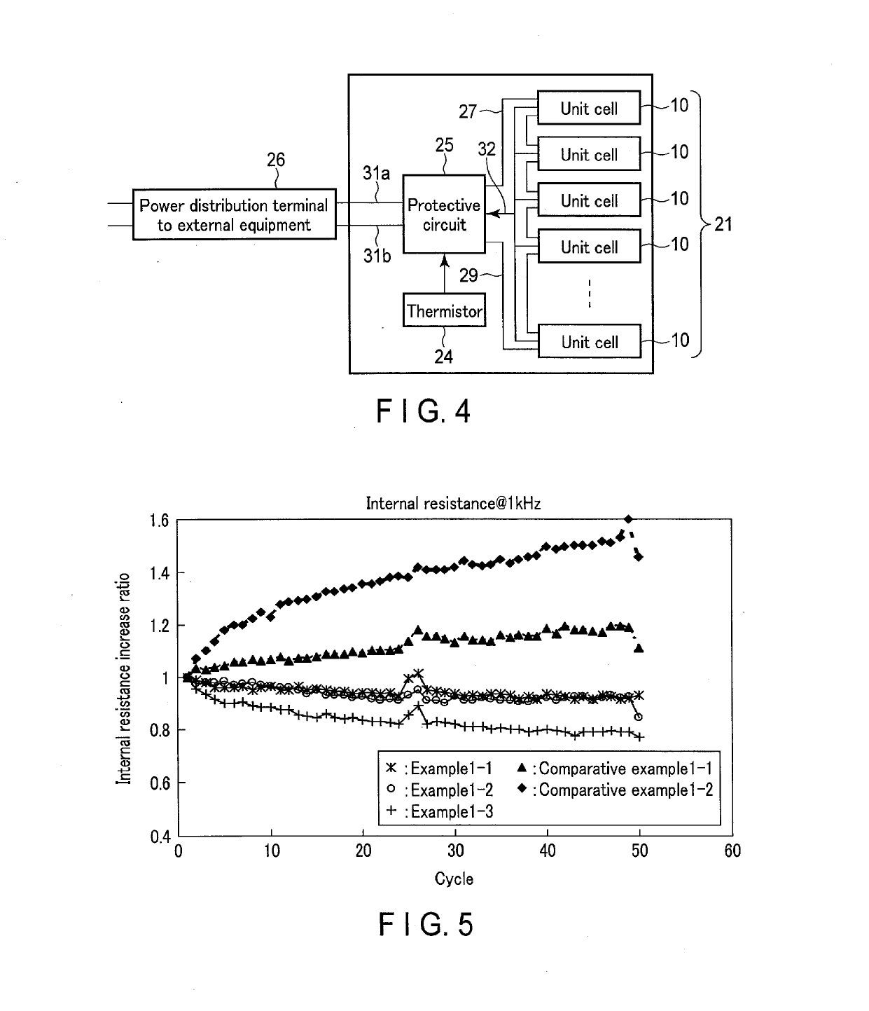

FIG. 3 is an exploded perspective view of the example of the battery pack according to the second embodiment. FIG. 4 is a block diagram showing an electric circuit of the battery pack shown in FIG. 3.

A battery pack 100 shown in FIGS. 3 and 4 includes a plurality of batteries (unit cells) 10 according to the first embodiment. In the battery 10, the negative electrode terminal 6 and the positive electrode terminal 7 project in the same direction. The plurality of batteries 10 are stacked in a state where the projection of the negative electrode terminals 6 and the projection of the positive electrode terminals 7 are aligned to one direction. As shown in FIGS. 3 and 4, the plurality of batteries 10 are connected in series to form a battery module 21. The battery module 21 is integrated into a single unit by an adhesive tape 22 as shown in FIG. 3.

A printed wiring board 23 is arranged to the side surface where the negative electrode terminals 6 and the positive electrode terminals 7 project. A thermistor 24, a protective circuit 25, and a power distribution terminal 26 to external equipment, each shown in FIG. 4, are mounted on the printed wiring board 23.

As shown in FIGS. 3 and 4, a positive-electrode-side wiring 27 of the battery module 21 is electrically connected to a positive-electrode-side connector 28 of the protective circuit 25 of the printed wiring board 23. Negative-electrode-side wiring 29 of the battery module 21 is electrically connected to a negative-electrode-side connector 30 of the protective circuit 25 of the printed wiring board 23.

A thermistor 24 is configured so as to detect a temperature of the unit cell 10. A detection signal concerning the temperature of the unit cell 10 is transmitted from the thermistor 24 to the protective circuit 25. The protective circuit 25 can break plus-side wiring 31a and a minus-side wiring 31b between the protective circuit and the power distribution terminal to the external equipment under a predetermined condition. The predetermined condition is, for example, the case where a detection temperature of the thermistor 24 reaches or exceed a predetermined temperature, or the case where over-charge, over-discharge, over-current, or the like of the battery 10 is detected. This detection method is performed on the individual batteries 10 or the whole battery module 21. When the detection is to be performed on the individual batteries 10, a battery voltage may be detected, or a positive electrode potential or a negative electrode potential may be detected. The detection on the whole battery module 21 can be performed by inserting into the individual battery 10 a lithium electrode to be used as a reference electrode. In the case of FIG. 4, wiring 32 for voltage detection is connected to each of the batteries 10, and a detection signal is transmitted to the protective circuit 25 through the wiring 32.

In the battery module 21, protective sheets 33 made of rubber or resin are arranged on three side surfaces except for the side surface where the negative electrode terminals 6 and the positive electrode terminals 7 project. A block-like protective block 34 made of rubber or resin is disposed between the printed wiring board 23 and the side surface where the positive electrode terminals 6 and the negative electrode terminals 7 project.

This battery module 21 is accommodated in a package 35 along with the protective sheets 33, the protective block 34, and the printed wiring board 23. That is, the protective sheets 33 are arranged respectively on both inner side surfaces in a long-side direction of the housing container 35 and an inner side surface in a short-side direction, and the printed wiring board 23 is disposed on the other inner side surface in the short-side direction. The battery module 21 is located in a space surrounded by the protective sheets 33 and the printed wiring board 24. A lid 36 is fitted to the upper surface of the housing container 35.

For fixing the battery module 21, a thermal shrinkage tape may be used in place of the adhesive tape 22. In this case, after the protective sheet is disposed on each side surface of the battery module and a thermal shrinkage tube is wound, the thermal shrinkage tube is thermally shrunk, to bind the battery module.

While the batteries 10 shown in FIGS. 3 and 4 are connected in series, they can be connected in parallel so as to increase a battery capacity. Further, the parallel connection and the serial connection can be combined. Naturally, the assembled battery packs can also be connected in series and/or parallel.

Further, the aspect of the battery pack can be changed as appropriate according to the application thereof. A preferable application of the battery pack according to the second embodiment is one required to have large-current characteristics and cycle characteristics. Specific examples thereof include a battery pack for a power source of a digital camera, and a battery pack for use in a vehicle such as a two-wheeled or four-wheeled hybrid electric car, a two-wheeled or four-wheeled electric car, and an assist bicycle. Especially, the battery pack for vehicle use is preferred.

Since the battery pack according to the second embodiment includes the nonaqueous electrolyte battery according to the first embodiment, it is possible to exhibit improved cycle life characteristics, and restrain the increase in impedance.

### EXAMPLES

Hereinafter, the present invention will be described with reference to the Examples, but should not be limited to the examples described below without departing from the spirit of the invention.

### Examples 1-1 to 1-3

In Examples 1-1 to 1-3, electrodes (positive electrodes) of Examples 1-1 to 1-3 were produced in the following procedure, and using the produced electrodes, half cells using three electrodes beaker cells were produced for evaluating a resistance change at charge-and-discharge cycles.

First, lithium iron phosphate LiFePO₄ (specific surface area: 11 m²/g) as the positive electrode active material, and acetylene black and graphite as the conductive agent were provided. Further, as the positive electrode binder, a solution of polyacrylic acid having an average molecular weight of 450000 in N-methylpyrrolidone (NMP), a solution of polyacrylic acid with an average molecular weight of 3000000 and an aqueous solution of polyacrylic acid with an average molecular weight of 3000000 were prepared, respectively.

Next, the lithium iron phosphate, the acetylene black, the graphite, and the solution of the polyacrylic acid having the average molecular weight of 450000 in NMP were mixed together, to obtain a slurry for producing the positive electrode of Example 1-1. At this time, as blending ratios, the lithium iron phosphate, the acetylene black, the graphite, and the polyacrylic acid (except NMP) were blended in a proportion of 90 parts by mass, 3 parts by mass, 2 parts by mass, and 5 parts by mass, respectively. Similarly, the lithium iron phosphate, the acetylene black, the graphite, and the NMP solution of the polyacrylic acid with the average molecular weight of 3000000 were mixed together to obtain a slurry for producing the positive electrode of Example 1-2. At this time, the lithium iron phosphate, the acetylene black, the graphite, and the polyacrylic acid (except NMP) were blended in a proportion of 90 parts by mass, 3 parts by mass, 2 parts by mass, and 5 parts by mass, respectively. Similarly, the lithium iron phosphate, the acetylene black, the graphite, and the aqueous solution of the polyacrylic acid with the average molecular weight of 3000000 were mixed together to obtain a slurry for producing the positive electrode of Example 1-3. At this time, the lithium iron phosphate, the acetylene black, the graphite, and the polyacrylic acid (except NMP) were blended in a proportion of 90 parts by mass, 3 parts by mass, 2 parts by mass, and 5 parts by mass, respectively.

Next, the slurry of each of Examples 1-1 to 1-3 was applied onto aluminum current collecting foil. The applied film was dried, and then roll-pressed, to produce an electrode with a density of 2.2 to 2.3 g/cm³. Specifically, using the slurry of Example 1-1, the electrode of Example 1-1 with a density of 2.29 g/cm³ was produced. Using the slurry of Example 1-2, the electrode of Example 1-2 with a density of 2.26 g/cm³ was produced. Using the slurry of Example 1-3, the electrode of Example 1-3 with a density of 2.27 g/cm³ was produced.

Subsequently, using the produced electrodes of Examples 1-1 to 1-3, evaluation cells of Examples 1-1 to 1-3 were each produced in the following procedure.

First, in a dry argon atmosphere, the electrode (20×20 mm-square) as a working electrode and a lithium metal as a counter electrode were made to face each other via a glass filter as the separator, and put into a three-electrodes beaker cell. Further, a lithium metal as the reference electrode was inserted into the three-electrode glass cell so as not to come into contact with the working electrode and the counter electrode. Subsequently, each of the working electrode, the counter electrode, and the reference electrode was connected to each of terminals of the glass cell.

Meanwhile, a nonaqueous electrolyte was dissolved in a solvent to prepare a nonaqueous electrolytic solution. As the solvent of the electrolytic solution, there was used a mixed solvent obtained by mixing ethylene carbonate (EC) with diethyl carbonate (DEC) at a volume ratio of 1:2. As the electrolyte in the electrolytic solution, LiPF₆ was used. A concentration of the electrolyte in the electrolytic solution was set to 1.0 mol/L.

Subsequently, the above nonaqueous electrolytic solution was poured into the glass cell, and the glass cell was sealed in a state where the separator, the working electrode, the counter electrode, and the reference electrode were sufficiently impregnated with the electrolytic solution. Thus, the evaluation cells of Examples 1-1 to 1-3 were produced.

A charge-and-discharge cycle test was performed on the evaluation cells of Examples 1-1 to 1-3 as thus produced in an environment at 45° C. A charge-and-discharge rate was set to 1 C. A voltage range was set to 4.25 to 2.5 V (vs. Li/Li⁺). An alternating-current impedance measurement was performed at a frequency of 1 kHz upon each completion of one cycle. FIG. 5 shows the result thereof.

### Comparative Examples 1-1 and 1-2

In each of Comparative Examples 1-1 and 1-2, an electrode (positive electrode) was produced in the same manner as in Examples 1-1 to 1-3 except that the positive electrode binder was changed as below. Using these electrodes, evaluation cells of Comparative Examples 1-1 and 1-2 were produced, respectively.

In Comparative Example 1-1, PVDF (#1710, manufactured by Kureha Battery Materials Japan Co., Ltd.) was used as the positive electrode binder. In Comparative Example 1-2, a copolymer of acrylonitrile and acrylic acid (molecular weight: 500000, content of a carboxyl group: 0.05 mol %) was used as the positive electrode binder.

A charge-and-discharge cycle test similar to that of the Examples 1-1 to 1-3 was performed on each of the evaluation cells of Comparative Examples 1-1 and 1-2. FIG. 5 shows the result thereof.

(Results)

It is found from the results shown in FIG. 5 that a resistance increase due to the cycles can be restrained more in Examples 1-1 to 1-3 as compared with Comparative Examples 1-1 and 1-2. The reason for this is considered to be that the polyacrylic acid binder has exerted the effect of restraining the resistance increase in the charge and discharge cycle. This effect was also confirmed when the solvent of the slurry at the time of producing the electrode was either NMP or water, and a similar effect was also seen even when the molecular weights were 450000 and 3000000 which are different from each other. It is considered that in the case of the glass cell, moisture easily gets into the cell and the effect is thus easy to be confirmed, whereas in the case of an actual cell (laminate cell, can cell), the effect is exerted when moisture is brought into the cell by the negative electrode material.

### Examples 2-1 to 2-13

In each of Examples 2-1 to 2-13, electrodes, namely a positive electrode and a negative electrode, were produced in the same manner as in Examples 1-1 to 1-3 except for using a positive electrode active material, a positive electrode binder, a negative electrode active material, and a negative electrode binder, which are shown in Table 1 below.

Note that densities of the produced electrodes were made different from one another as shown below in accordance with the used active materials. A positive electrodes (Examples 2-1 to 2-8 and Examples 2-10 to 2-13) including lithium iron phosphate (LFP, LiFePO₄): 2.2 g/cm³. A positive electrode (Example 2-9) including lithium manganese iron phosphate (LMFP, LiFe_{0.2}Mn_{0.8}PO₄): 1.8 g/cm³. A negative electrodes (Examples 2-1 to 2-6, and 2-9 to 2-13) including lithium titanate having a spinel-type structure (LTO, Li₄Ti₅O₁₂): 2.2 g/cm³. A negative electrode (Example 2-7) including monoclinic β-type titanium dioxide (TiO₂ (B)): 2.2 g/cm³. A negative electrode (Example 2-8) including titanium-niobium composite oxide (NTO, TiNb₂O₇): 2.6 g/cm³.

Further, in each of Examples 2-1 to 2-9, 2-11, and 2-13, as the positive electrode binder, polyacrylic acid with an average molecular weight of 450000 was used as a solution in NMP. In Example 2-10, as the positive electrode binder, sodium polyacrylate with an average molecular weight of 3000000 was used as an aqueous solution. In Comparative Example 2-12, PVDF (#1710, manufactured by Kureha Battery Materials Japan Co., Ltd.) was used as a solution in NMP.

Further, in each of Comparative Examples 2-1 to 2-10, as the negative electrode binder, PVDF (#1710, manufactured by Kureha Battery Materials Japan Co., Ltd.) was used as a solution in NMP. In Example 2-11, as the negative electrode binder, 2.5 parts by mass of carboxymethyl cellulose (CMC, manufactured by Daicel FineChem Ltd.) and 2.5 parts by mass of SBR (TRD2001, manufactured by JSR Corporation) were used in a water solvent. In each of Examples 2-12 and 2-13, as the negative electrode binder, sodium polyacrylate with an average molecular weight of 3000000 was used as an aqueous solution.

A specific surface area of each of the active materials was obtained by BET specific surface area measurement, with the positive electrode active material powder and the negative electrode active material powder each taken as a sample. A BET specific surface area measurement device manufactured by Yuasa Ionics Co., Ltd. was used, and a nitrogen gas was used as an adsorption gas.

Using the positive electrodes and the negative electrodes of Examples 2-1 to 2-13 produced as above, test cells of Examples 2-1 to 2-13 were produced in the following procedure.

First, each of the produced positive electrodes and negative electrode was cut into strip forms, to produce a plurality of positive electrode pieces and a plurality of negative electrode pieces. Next, a separator of a band-like porous film, made of polyethylene and having a thickness of 20 μm, was horizontally put. Subsequently, at the left end of the separator, one of the positive electrode pieces in the cutting-strip form was put, and the separator was folded to left along the right end of the positive electrode piece. Then, on the folded separator, one of the negative electrode pieces in the cutting-strip form was put, and the separator was folded to right along the left end of the negative electrode piece. By repeating these procedures, the positive electrodes and the negative electrodes were stacked while sandwiching the separator therebetween.

Then, hot pressing for shaping was performed on the laminate thus obtained. The positive electrode pieces in the stack were electrically connected to the positive electrode terminal, and the negative electrode pieces in the stack were electrically connected to the negative electrode terminal, to obtain a unit. The unit thus obtained was put into a laminate container member of a laminate, and the nonaqueous electrolyte was then poured into the container member. Finally, the container member was sealed, to produce each of flat-shaped nonaqueous electrolyte secondary batteries (laminate cells) of Examples 2-1 to 2-13 with a capacity of 1 Ah.

This cell was subjected to a 1 C/1 C charge-and-discharge cycle test under an environment of 80° C. DC resistance after 100 cycles was measured, and a ratio of the measured resistance to initial DC resistance was obtained and taken as a resistance increase ratio. The DC resistance was measured at 50% SOC at a pulse of 0.2 second. Table 1 shows a ratio of the resistance increase and a ratio of the initial resistance for each cell. Should be noted that Table 1 shows the ratios of the initial resistance as relative values, with the initial resistance of the cell of Example 2-2 being 1.

TABLE 1
(Example 2)

| | Positive Electrode | | | Negative Electrode | | | | Initial |
|---|---|---|---|---|---|---|---|---|
| | | Specific | | | Specific | | | Resistance |
| | | Surface | | | Surface | | Resistance | Ratio |
| Sample | Active | Area | | Active | Area | | Increase | (vs. |
| Cell | Material | (m²/g) | Binder | Material | (m²/g) | Binder | Ratio | Example 2-2) |
| Example 2-1 | LFP | 4 | Polyacrylic Acid | LTO | 3 | PVDF | 0.97 | 1.67 |
| Example 2-2 | LFP | 11 | Polyacrylic Acid | LTO | 3 | PVDF | 1.01 | 1 |
| Example 2-3 | LFP | 15 | Polyacrylic Acid | LTO | 3 | PVDF | 1.05 | 0.76 |
| Example 2-4 | LFP | 11 | Polyacrylic Acid | LTO | 3 | PVDF | 1.01 | 1 |
| Example 2-5 | LFP | 11 | Polyacrylic Acid | LTO | 5 | PVDF | 1.07 | 0.95 |
| Example 2-6 | LFP | 11 | Polyacrylic Acid | LTO | 7 | PVDF | 1.13 | 0.92 |
| Example 2-7 | LFP | 11 | Polyacrylic Acid | TiO₂(B) | 16 | PVDF | 1.2 | 1.05 |
| Example 2-8 | LFP | 11 | Polyacrylic Acid | NTO | 13 | PVDF | 1.18 | 0.91 |
| Example 2-9 | LMFP | 25 | Polyacrylic Acid | LTO | 3 | PVDF | 1.03 | 0.77 |
| Example 2-10 | LFP | 11 | Sodium Polyacrylate | LTO | 3 | PVDF | 0.98 | 0.97 |
| | | | (in Water solvent) | | | | | |
| Example 2-11 | LFP | 11 | Polyacrylic Acid | LTO | 3 | CMC/SBR | 0.97 | 1.03 |
| Example 2-12 | LFP | 11 | PVDF | LTO | 3 | Polyacrylic | 1.19 | 0.95 |
| | | | | | | Acid | | |
| Example 2-13 | LFP | 11 | PolyacrylicAcid | LTO | 3 | Polyacrylic | 0.94 | 1.35 |
| | | | | | | Acid | | |

LFP: Lithium Iron Phosphate;
LMFP: Lithium Manganese Iron Phosphate;
LTO: Lithium Titanate having spinel-type sturcure (Li₄Ti₅O₁₂);
TiO₂(B): β-type Titanium Composite Oxide;
NTO: Titanium-niobium Composite Oxide (TiNb₂O₇)

The results of Table 1 show that the use of the polyacrylic acid binder for the positive electrode has reduced the ratio of the resistance increase after cycles under the high-temperature to 1.2 times or less. It is found that all the cells exhibit initial resistance less than double that of the cell of Example 2-2.

### Comparative Examples 2-1 to 2-8 and Comparative Examples 3-1 to 3-8

In Comparative Examples 2-1 to 2-8 and Comparative Examples 3-1 to 3-8, electrodes, namely positive electrodes and negative electrodes, were produced in the same manner as in Examples 1-1 to 1-3 except for using positive electrode active materials, positive electrode binders, negative electrode active materials, and negative electrode binders which are shown in Tables 2 and 3 below.

In the same manner as in the description of Examples 2-1 to 2-13, densities of the produced electrodes were made different from one another in accordance with the active materials used.

Using the positive electrodes and the negative electrodes of Comparative Examples 2-1 to 2-8 and Comparative Examples 3-1 to 3-8 produced as above, test cells of Comparative Examples 2-1 to 2-8 and Comparative Examples 3-1 to 3-8 were produced in a similar procedure to that in the description of Examples 2-1 to 2-13.

A charge-and-discharge cycle test in the same manner as in the description of Examples 2-1 to 2-13 was performed on each of the test cells of Comparative Examples 2-1 to 2-8 and Comparative Examples 3-1 to 3-8. Tables 2 and 3 show the results thereof.

TABLE 2
(Comparative Example 2)

| | Positive Electrode | | | Negative Electrode | | | | Initial |
|---|---|---|---|---|---|---|---|---|
| | | Specific | | | Specific | | | Resistance |
| | | Surface | | | Surface | | Resistance | Ratio |
| | Active | Area | | Active | Area | | Increase | (vs. |
| Sample Cell | Material | (m²/g) | Binder | Material | (m²/g) | Binder | Ratio | Example 2-2) |
| Comparative | LFP | 4 | PVDF | LTO | 3 | PVDF | 2.11 | <2 |
| Example 2-1 | | | | | | | | |
| Comparative | LFP | 11 | PVDF | LTO | 3 | PVDF | 2.23 | <2 |
| Example 2-2 | | | | | | | | |
| Comparative | LFP | 15 | PVDF | LTO | 3 | PVDF | 2.28 | <2 |
| Example 2-3 | | | | | | | | |
| Comparative | LFP | 11 | PVDF | LTO | 3 | PVDF | 2.23 | <2 |
| Example 2-4 | | | | | | | | |
| Comparative | LFP | 11 | PVDF | LTO | 5 | PVDF | 2.67 | <2 |
| Example 2-5 | | | | | | | | |
| Comparative | LFP | 11 | PVDF | LTO | 7 | PVDF | 4.3 | <2 |
| Example 2-6 | | | | | | | | |
| Comparative | LFP | 11 | PVDF | TiO₂(B) | 16 | PVDF | 3.82 | <2 |
| Example 2-7 | | | | | | | | |
| Comparative | LFP | 11 | PVDF | NTO | 13 | PVDF | 3.25 | <2 |
| Example 2-8 | | | | | | | | |
| Comparative | LMFP | 25 | PVDF | LTO | 3 | PVDF | 2.2 | <2 |
| Example 2-9 | | | | | | | | |

TABLE 3
(Comparative Example 3)

| | Positive Electrode | | | Negative Electrode | | | | Initial |
|---|---|---|---|---|---|---|---|---|
| | | Specific | | | Specific | | | Resistance |
| | | Surface | | | Surface | | Resistance | Ratio |
| | Active | Area | | Active | Area | | Increase | (vs. |
| Sample Cell | Material | (m²/g) | Binder | Material | (m²/g) | Binder | Ratio | Example 2-2) |
| Comparative | LFP | 2 | Polyacrylic Acid | LTO | 3 | PVDF | 0.98 | 2.28 |
| Example 3-1 | | | | | | | | |
| Comparative | LFP | 30 | Polyacrylic Acid | LTO | 3 | PVDF | 2.44 | 0.95 |
| Example 3-2 | | | | | | | | |
| Comparative | LMFP | 8 | Polyacrylic Acid | LTO | 3 | PVDF | 1.05 | 2.06 |
| Example 3-3 | | | | | | | | |
| Comparative | LMFP | 51 | Polyacrylic Acid | LTO | 3 | PVDF | 2.85 | 0.67 |
| Example 3-4 | | | | | | | | |
| Comparative | LFP | 11 | Polyacrylic Acid | LTO | 0.7 | PVDF | 1.02 | 2.21 |
| Example 3-5 | | | | | | | | |
| Comparative | LFP | 11 | Polyacrylic Acid | LTO | 30 | PVDF | 2.32 | 1.08 |
| Example 3-6 | | | | | | | | |
| Comparative | LFP | 11 | Polyacrylic Acid | NTO | 1 | PVDF | 1.12 | 2.76 |
| Example 3-7 | | | | | | | | |
| Comparative | LFP | 11 | Polyacrylic Acid | NTO | 30 | PVDF | 3.03 | 1.13 |
| Example 3-8 | | | | | | | | |

The results shown in Table 2 shows that, when a polyacrylic acid compound was not used as the binder for either the positive electrode or the negative electrode, the ratio of resistance increase due to the cycles at high temperature was more than doubled. Furthermore, the results shown in Table 3 shows that, when the specific surface area of the positive electrode active material or the negative electrode active material was excessively smaller than a predetermined range, the initial resistance was more than doubled with respect to Example 2-2, and when the specific surface area was excessively large, the ratio of resistance increase due to the cycles at high temperature was more than doubled with that of Example 2-2

### Examples 3-1 to 3-4

In Examples 3-1 to 3-4, electrodes, namely positive electrodes and negative electrodes, were produced in the same manner as in Example 2-1 except for using positive electrode binders shown in Table 4 below.

Using the positive electrodes and the negative electrodes of Examples 3-1 to 3-4, test cells of Examples 3-1 to 3-4 were produced in a similar procedure to that in the description of Examples 2-1 to 2-13.

A charge-and-discharge cycle test in the same manner as in the description of Examples 2-1 to 2-13 was performed on each of the test cells of Examples 3-1 to 3-4. Table 4 shows the results thereof.

TABLE 4
(Example 3)

| | | | | | Resistance |
|---|---|---|---|---|---|
| | Positive Electrode Binder | | [symbol] | | Increase |
| Sample Cell | \textcircled{1} | \textcircled{2} | \textcircled{1} | \textcircled{2} | Ratio |
| Example | Copolymer of | Polyacrylic | 70 | 30 | 1.08 |
| 3-1 | Acrylonitrile and | Acid | | | |
| | Acrylic Acid | | | | |
| Example | PVDF | Polyacrylic | 70 | 30 | 1.19 |
| 3-2 | | Acid | | | |
| Example | Sodium Polyacrylate | SBR | 60 | 40 | 1.01 |
| 3-3 | (in water solvent) | | | | |
| Example | Polyacrylic Acid | SBR | 60 | 40 | 0.98 |
| 3-4 | (in water solvent) | | | | |

The result shown in Table 4 shows that in Examples 3-1 and 3-2 where an acrylonitrile-acrylic acid polymer or PVDF (#1710, Kureha) was used as the binder in addition to the polyacrylic acid, and in Examples 3-3 and 3-4 where polyacrylic acid or sodium polyacrylate was used along with SBR in a water solvent, the ratio of resistance increase due to the cycles at high temperature was 1.2 times or less.

The nonaqueous electrolyte battery according to at least one of embodiments and Examples described above includes: the positive electrode layer including the positive electrode binder and at least one olivine-type compound having a specific surface area of a certain value; and the negative electrode layer including at least one oxide having a specific surface area of a certain value. The positive electrode binder and/or the negative electrode binder include at least one polyacrylic acid compound. Due to these, the nonaqueous electrolyte battery according to the first embodiment can exhibit improved cycle life characteristics, and can restrain the increase in impedance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A nonaqueous electrolyte battery, comprising:
a positive electrode comprising a positive electrode layer comprising a positive electrode binder and at least one compound selected from the group consisting of an olivine-type lithium iron phosphate having a specific surface area of 3 m²/g or more and 25 m²/g or less, an olivine-type lithium manganese phosphate having a specific surface area of 15 m²/g or more and 50 m²/g or less, and an olivine-type lithium manganese iron phosphate having a specific surface area of from 15 m²/g or more and 50 m²/g or less;
a negative electrode comprising a negative electrode layer comprising a negative electrode binder and at least one oxide selected from the group consisting of a lithium titanate having a spinel-type structure and a specific surface area of 2 m²/g or more and 20 m²/g or less, a monoclinic β-type titanium composite oxide having a specific surface area of 10 m²/g or more and 30 m²/g or less, and a niobium-containing titanium composite oxide having a specific surface area of 5 m²/g or more and 25 m²/g or less; and
a nonaqueous electrolyte,
wherein the positive electrode binder and/or the negative electrode binder comprises at least one compound selected from the group consisting of a polyacrylic acid, a polyacrylate, and a copolymer thereof.

2. The nonaqueous electrolyte battery according to claim 1, wherein
the positive electrode binder and/or the negative electrode binder comprise the polyacrylic acid in a proportion of 10% by mass or more, and
the positive electrode binder and/or the negative electrode binder further comprise a polyacrylonitrile-based binder.

3. The nonaqueous electrolyte battery according to claim 1, wherein
the positive electrode binder and/or the negative electrode binder comprise, in a proportion of 10% by mass or more, the at least one compound, and
the positive electrode binder and/or the negative electrode binder further comprise a styrene-butadiene copolymer.

4. The nonaqueous electrolyte battery according to claim 1, wherein the positive electrode binder comprises the at least one compound.

5. The nonaqueous electrolyte battery according to claim 1, wherein each of the positive electrode binder and the negative electrode binder comprises the at least one compound.

6. The nonaqueous electrolyte battery according to claim 1, wherein the positive electrode layer comprises the positive electrode binder and particles of the at least one compound selected from the group consisting of particles of the olivine-type lithium iron phosphate, particles of the olivine-type lithium manganese phosphate, and particles of the olivine-type lithium manganese iron phosphate.

7. The nonaqueous electrolyte battery according to claim 6, wherein the positive electrode layer comprises a carbonaceous coating film provided on a surface of the particles of the at least one compound.

8. The nonaqueous electrolyte battery according to claim 1, wherein the negative electrode layer comprises the negative electrode binder and particles of the at least one oxide selected from the group consisting of particles of the lithium titanate, particles of the monoclinic β-type titanium composite oxide, and particles of the niobium-containing titanium composite oxide.

9. A battery pack comprising the nonaqueous electrolyte battery according to claim 1.

10. The battery pack according to claim 9, further comprising:
an external power distribution terminal; and
a protective circuit.

11. A battery pack comprising nonaqueous electrolyte batteries, each of the nonaqueous electrolyte batteries according to claim 1;
wherein the nonaqueous electrolyte batteries are connected in series, in parallel or with a combination of series connection and parallel connection.

12. The battery pack according to claim 11, further comprising:
an external power distribution terminal; and
a protective circuit.

13. A vehicle comprising the battery pack according to claim 9.
